(19) United States
(12) Patent Application Publication
(10) Pub. No.: US 2026/0047555 A1
(43) Pub. Date: Feb. 19, 2026

(54) ANIMAL HARNESS WITH SIDE-CONNECT LOOP SYSTEM AND METHOD

(71) Applicant: Canada Pooch Ltd., Toronto (CA)

(72) Inventors: Danielle McGuire, London (CA); Casey Barber, Toronto (CA)

(21) Appl. No.: 19/261,285

(22) Filed: Jul. 7, 2025

Related U.S. Application Data
(60) Provisional application No. 63/668,472, filed on Jul. 8, 2024.

(51) Int. Cl. A01K 27/00; A01K 15/02

(52) U.S. Cl. CPC A01K 27/002; A01K 15/02

(57) ABSTRACT

A method of walking and training a dog that includes: putting a harness on a dog; passing a leash through a loop passage of the harness; coupling a coupling element of the leash with a leash-coupler disposed at the center of the chest of the dog to couple the leash to the harness; and walking parallel and adjacent to the dog on the same side as the loop passage through which the leash strap of the leash is slidably disposed. Where the dog moves away or otherwise pulls on the leash, the slidable coupling between the leash strap through the loop passage causes slack in the leash strap between the coupling loop and the leash-coupler to be pulled taught, with the coupling loop then acting as a point of resistance.

### CROSS-REFERENCE TO RELATED APPLICATIONS

This application is a non-provisional of and claims the benefit of U.S. Provisional Application No. 63/668,472, filed Jul. 8, 2024 and entitled “ANIMAL HARNESS WITH SIDE CONNECT LOOP SYSTEM AND METHOD” with attorney docket number 0109579-010PRO. This application is hereby incorporated herein by reference in its entirety and for all purposes.

### BRIEF DESCRIPTION OF THE DRAWINGS

FIG. 1 is an exemplary perspective view illustrating an embodiment of a harness.

FIG. 2 is an exemplary perspective view illustrating another embodiment of a harness.

FIG. 3 is an exemplary perspective view illustrating an embodiment of a harness being worn by a dog with a leash connected to the harness.

FIG. 4 is an exemplary perspective view illustrating a user putting a harness on a dog.

FIG. 5 is an exemplary perspective view illustrating a user clipping a torso strap of a harness together around a dog.

FIG. 6 is an exemplary perspective view illustrating a user adjusting the fit of a harness on the dog.

FIG. 7 is an exemplary perspective view illustrating a user passing the end of a leash through a loop passage of a harness.

FIG. 8 is an exemplary front view illustrating a user clipping a carabiner of a leash to a leash coupler of a harness.

FIG. 9 is an exemplary side view illustrating a user walking a dog with a leash attached to a harness.

FIG. 10 is an exemplary side view illustrating a user grabbing a handle of a harness.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Walking dogs on a leash is a common practice for pet owners, trainers, and handlers, providing exercise, structure, and bonding opportunities between dogs and humans. However, many dogs (e.g., dogs that are young, energetic, or insufficiently trained) exhibit leash pulling behavior. Leash pulling can lead to a variety of challenges, including reduced enjoyment of walks, increased physical strain on the handler, and safety concerns for both the dog and the person. In many cases, dogs that pull excessively may lunge unpredictably, strain against the leash, or attempt to redirect their movement in ways that make control difficult, especially in distracting or stimulating environments.

Training a dog to walk politely on a leash (e.g., “loose-leash walking”) can be a foundational skill in obedience training. Common training techniques include the use of verbal commands, treats, or leash corrections to encourage desired behavior and discourage pulling. These techniques can be effective, but require consistent timing, handler awareness, and often depend heavily on the dog's responsiveness to feedback. When a dog has already begun pulling, corrective measures tend to become less effective, as the dog is often highly stimulated or focused on a specific external stimulus, making redirection or correction more difficult.

Existing solutions for reducing leash pulling vary and include head halters, chest clip harnesses, traditional back-clip harnesses, and various types of collars. While each of these products offers a mechanism for discouraging pulling, many present limitations. Some devices may be uncomfortable for the dog or may cause injury if used improperly. Others may fail to effectively redirect the dog's momentum or focus, particularly before the dog initiates a pull.

Additionally, many current systems do not provide sufficient control for the handler in situations where quick redirection or corrective guidance is needed.

As such, there is a continuing need for improved systems and methods for managing leash pulling behavior in dogs. In particular, there is a need for solutions that allow for earlier redirection of a dog before pulling begins, provide enhanced control during walks, reduce pulling tendencies overall, and support more effective communication between the handler and dog during training or correction. These needs remain unmet or inadequately addressed by many current products and training approaches in the field.

Various embodiments discussed herein provide a harness that looks good but also effectively redirects a dog before and/or while the dog is pulling. In various embodiments, it can be desirable to provide a harness that is durable, comfortable for the dog and easy to put on. A harness of various embodiments can be used for additional control during walks or training, can help the dog respond better to corrections, and the like. Various embodiments include an innovative connection point that effectively resists pulling by dogs, which offers a distinct advantage in no-pull functionality. Some examples include a leash being threaded through a loop on the side of the harness and coupled to a ring at the center of the chest of the dog. Such a configuration in various embodiments can create a similar feel to a bungee leash which allows for more of a slow stop instead of a hard stop and the loop can act as a second point of resistance for the pulling dog in addition to a coupling at the center of the chest.

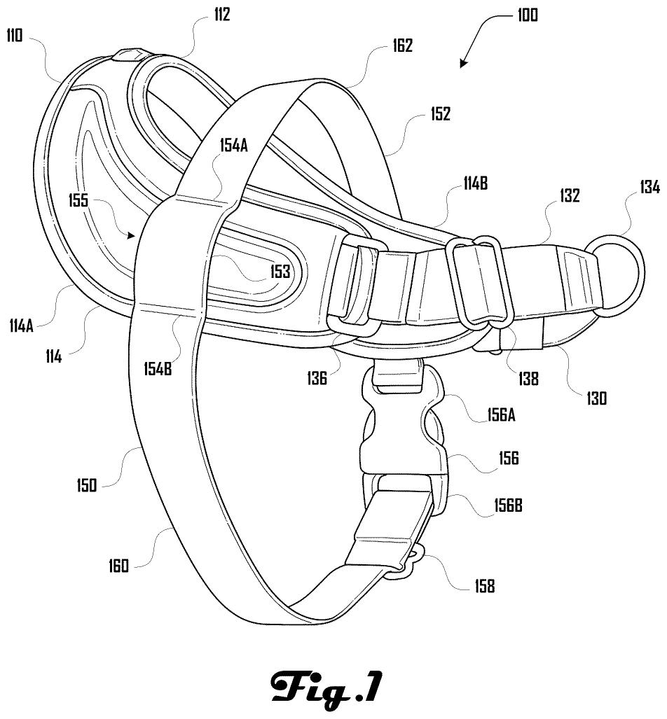

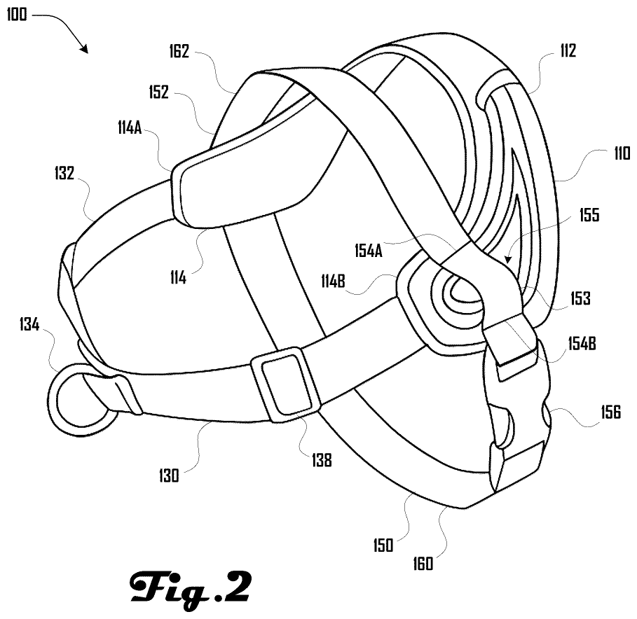

Turning to FIGS. 1 and 2, example embodiments of a harness 100 are illustrated. For example, FIG. 1 shows one example embodiment of a harness 100 that comprises a handle body 110, a front strap assembly 130 coupled to the handle body 110 and a torso strap assembly 150 that is also coupled to the handle body 110.

In the example of FIG. 1, the handle body 110 comprises a top handle 112, which is a curved U-shaped body that extends downward to a pair of arms 114A, 114B. The arms 114 then extend laterally, where the front strap assembly 130 is coupled at respective distal ends of the arms 114A, 114B. The front strap assembly 130 includes a front strap 132 and a leash-coupler 134 disposed centrally on the front strap assembly 130. The front strap 132 is coupled to the handle body 110 at the ends of the arms 114 of the of the handle body 110 via front-strap couplers 136. The front strap assembly 130 further includes adjustment hardware 138, which can be configured to adjust the length/fit of the front strap assembly 130 as discussed herein.

The torso strap assembly 150 comprises a torso strap 152 that defines a pair of coupling loops 153 respectively on the arms 114 of the handle body 110, which can be defined by lengths of the torso strap 152 coupled to the arms 114 via top and bottom loop couplings 154A, 154B. The loops 153 and an external face of the arms 114 define a loop passage 155, which can be configured to hold a leash as discussed herein. The torso strap assembly 150 further comprises a clip 156 and torso strap adjustment hardware 158, which allow a lower portion 160 of the torso strap 152 to be coupled and decoupled via the clip 156 and for the length/fit of the lower portion 160 of the torso strap 152 to be adjusted as discussed herein. The torso strap assembly 150 can further comprise a top portion 162 defined by a portion of the torso strap 152 between where the torso strap 152 is coupled to the respective arms 114 via respective top and bottom couplings 154A, 154B of the coupling loops 153.

In various embodiments, the handle body 110 can be a soft, flexible and yet semi-rigid body, which in some examples can include padded neoprene, fabric, or the like. In some examples, the handle body 110 can comprise rigid support made of plastic, metal, or the like. As shown in various examples, the handle body 110 comprises a top handle 112, which can be a curved U-shaped body that extends downward to the pair of arms 114A, 114B. The arms 114 can extend laterally, and in some examples can define respective front faces having respective planes that are generally parallel to each other and perpendicular to a peak tangent of the top handle 112. Similarly, in various embodiments the top handle 112 can have a main axis that is perpendicular to main axes of the arms 114A, 114B, with the main axes of the arms 114A, 114B being parallel to each other in various examples.

As discussed in more detail herein, the handle body 110 can be configured to be disposed on the sides of an animal such that top handle 112 remains spaced apart from the back of the animal creating a cavity between the top handle 112 and the back of the animal such that the top handle 122 is more easily graspable by a user. In various examples, the top portion 162 of the torso strap assembly 150 can be configured to rest on the back of the animal and have a length (e.g., a fixed length), that allows the top handle 112 to remain spaced apart from the back of the animal and creating a cavity between the top handle 112 and the back of the animal. In some embodiments, the distance between the back of the animal and the top handle 112 can be configured to be various suitable lengths, including 1.0, 1.5, 2.0, 2.5, 3.0, 3.5, 4.0, 4.5 inches, or the like, or a range between such example values.

Also, while various examples of a handle body 110 can be configured and shaped as shown and discussed herein, it should be clear that other embodiments can include a handle body 110 of various suitable configurations and the examples herein should not be construed to be limiting. For example, in some embodiments, the top handle 112 can comprise a bar or other suitable element that defines a handle.

In various embodiments, the front strap 132 of the front strap assembly 130 can be made of various suitable materials such as 1.5-inch-wide nylon webbing, but further embodiments can be made of any suitable material(s). In various embodiments the leash-coupler 134 can be a D-ring sewn into the front of the front strap assembly 130, but in further embodiments, the leash-coupler 134 can comprise various suitable elements such as a triangular ring, rectangular ring, O-ring, circular grommet, fabric loop, reinforced webbing loop, plastic loop, molded polymer eyelet, slotted buckle, snap-fit connector, magnetic clasp, hook-and-loop fastener strip, swiveling latch, rotating tether mount, quick-release clip, slide-in rail track, ball-and-socket coupling, snap button, interlocking tab and slot, hook-shaped bracket, screw-in eyelet, spring-loaded latch, pin-and-hole locking system, pivoting catch mechanism, carabiner-integrated loop, cord loop, elastic band loop, buttonhole-style opening, molded leash interface, snap hook, cam-lock connector, looped strap, knot-and-loop system, tether with integral fastener, magnetic tip, friction-fit plug, slotted latch end, wrap-and-tie segment, twist-lock coupler, or the like.

Additionally, the front strap assembly 130 can be coupled to the arms 114A, 114B in various suitable ways. While the example of FIG. 1 illustrates a front strap coupler 136 comprising a rectangular ring, in further embodiments the front strap assembly 130 can be coupled to the arms 114A, 114B via sewing, a weld, adhesive, hook and loop tape, or the like. Additionally, while in some embodiments the front strap assembly 130 can be permanently coupled to the arms 114A, 114B, in some embodiments such a coupling can be a removable coupling (e.g., via a clip, hook-and-loop tape, open loop, snaps, or the like). Additionally, in some embodiments, the strap assembly 130 can be in integral part of the handle body 110.

Similarly, while various examples of front strap adjustment hardware 138 are illustrated, it should be clear that any suitable adjustment mechanism(s) can be present on various portions of the handle body 110, front strap assembly 130, torso strap assembly 150, lower portion 160 of the torso strap assembly 150, upper portion of the torso strap assembly 150 and the like. For example, some embodiments can include front strap adjustment hardware 138 on one or both sides of the leash coupler 134, which in some examples can be desirable to allow the length/fit of the front strap assembly 130 to be adjusted while also allowing the leash coupler 134 to remain centrally disposed on the torso strap assembly 150 and centrally disposed on the chest of an animal wearing the harness 100.

However, in some embodiments, an adjustment mechanism can be specifically absent on various suitable parts of the handle body 110, front strap assembly 130, torso strap assembly 150, lower portion 160 of the torso strap assembly 150, upper portion of the torso strap assembly 162, and the like. For example, in various examples discussed herein, the handle body 110 and upper portion of the torso strap assembly 162 do not include an adjustment mechanism.

In various embodiments, the torso strap assembly 150 can comprise torso strap 152 made of a piece a nylon webbing (e.g., 1.5 inch width) that forms a loop and encircles the handle body 110, with the torso strap 152 coupled to respective external faces of the arms 114A, 114B of the handle body 110 via respective top and bottom loop couplings 154A, 154B. The top and bottom loop couplings 154A, 154B can be one or more stitches between the arms 114A, 114B and torso strap 152 in various examples. In various embodiments, the stitching of the top and bottom loop couplings 154A, 154B can be linear and parallel to each other; perpendicular to the main axis of the torso strap 152; parallel to the main axis of the front strap 132; and/or parallel to the main axis of the arms 114.

The torso strap 152 can define a pair of coupling loops 153 respectively on the arms 114 of the handle body 110 via lengths of the torso strap 152 coupled to the arms 114 via the top and bottom loop couplings 154A, 154B. The loops 153 and an external face of the arms 114 can define a loop passage 155, which can be configured to hold a leash as discussed herein. In various embodiments, the length of the loops 153 defined by the torso strap 152 can be greater than the distance between the top and bottom loop couplings 154A, 154B, which can cause the portion of the torso strap 152 that defines the loops 153 to bulge outward based on the rigidity of arms of the handle body 110 keeping the arms 114 planar. Such bulging of the loops 153 can be desirable in various embodiments for defining suitable open loop passage 155 (e.g., having a D-shape) that allows a leash to be easily passed through the loop passage 155 (e.g., a carabiner on an end of a leash and a length of the leash) and to provide minimal resistance to the body of the leash sliding through the loop passage 155 as discussed in more detail herein, which can be desirable in some examples for creating free movement and minimal friction of the leash within the side connect loop while also retaining the leash.

The loops can have various suitable shapes, including being D-shaped, circular, oval, rectangular, or the like. In some embodiments, a loop cavity defined by the side connect loop can have a central axis that is generally aligned with or parallel to a central axis of a dog wearing the harness, or can be at various suitable angles relative to the central axis of a dog wearing the harness such as +/−1, 2, 3, 4, 5, 6, 7, 8, 9, 10, 15, 20, 25, 30, 35, 40, 45 degrees, or the like, or a range between such example values.

In some embodiments, top and/or bottom loop couplings 154A, 154B can comprise any suitable coupling, including an adhesive, a weld, hook-and-loop tape, rivets, snaps, grommets, mechanical fasteners, compression fittings, molded joints, ultrasonic welding, thermal bonding, zip ties, buckles, barbed connectors, press-fit joints, toggles, clamps, interlocking tabs, sew-free heat-seal tape, magnetic connectors, interwoven braiding, crimped rings, stitched-reinforced glue joints, fused overlays, screw fasteners, slide-lock interfaces, eyelets with lacing, notched joints, ratcheting clips, tab-and-slot systems, chemical bonding agents, flexible polymer welds, fabric welding tape, or the like.

In various embodiments, the lower portion 160 of the torso strap assembly 150 further comprises a clip 156 and torso strap adjustment hardware 158, which allow the lower portion 160 of the torso strap 152 to be coupled and decoupled via the clip 156 and for the length/fit of the lower portion 160 of the torso strap 152 to be adjusted as discussed herein. Further embodiments can include any suitable type of adjustment system(s) and elements for coupling the lower portion 160 of the torso strap assembly 150 together. For example, some embodiments discussed herein include a clip 156 comprising male and female portions 156A, 156B; however, further embodiments can include any suitable type of coupling element, including a cam-lock buckle, side-release buckle, magnetic buckle, snap fastener, hook-and-loop fastener, ladder lock with release tab, quick-release pin, twist-lock fastener, toggle and loop, button and buttonhole, ratchet-style buckle, spring-loaded clasp, slide-and-lock tab, tension buckle, carabiner clip, belt-style tongue and frame buckle, sliding bar fastener, knotted loop, zip tie with releasable catch, press-stud connector, pivoting latch, bayonet-style connector, gear-lock coupler, hook-and-loop strap keeper, drawstring cinch with cord lock, a stretchable elastic loop with a retaining hook, or the like.

In various examples, the top portion 162 of the torso strap assembly 150 can be configured to rest on the back of the animal and have a length (e.g., a fixed length or adjustable), that allows the top handle 112 to remain spaced apart from the back of the animal and creating a cavity between the top handle 112 and the back of the animal. In various embodiments, the top portion 162 can be a continuous piece of material or can be releasably coupled together (e.g., via a clip 156 or the like). Additionally, the top portion 162 of the torso strap assembly 150 may or may not have an adjustable length.

Also, while various embodiments of the harness can comprise nylon webbing straps, it should be clear that any suitable straps can be used in further embodiments such as polyester webbing, polypropylene webbing, leather straps, faux leather, thermoplastic polyurethane (TPU) coated fabric, rubber-coated fabric, elastic bands, braided rope, paracord, canvas, cotton webbing, hemp webbing, aramid fiber webbing (e.g., Kevlar®), Dyneema® fiber straps, silicone straps, vinyl-coated polyester, neoprene-covered bands, biothane-coated straps, woven fiberglass, mesh-reinforced fabric, laminated fabric composites, bamboo fiber strapping, cork-reinforced fabric, recycled plastic strapping, molded flexible polymer strips, multi-layer textile laminates, or the like.

In various embodiments, the harness 100 can be essentially symmetrical (e.g., aside from clips 156, adjustment hardware, and the like) along a central plane of symmetry without any additional planes of symmetry. Also, the example of FIG. 1 is only one example embodiment and should not be construed as being limiting. Other embodiments are shown and described herein, including FIG. 2.

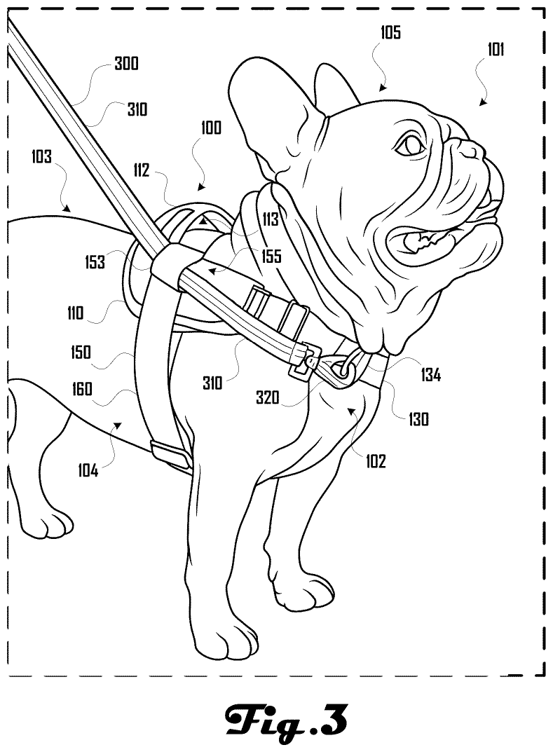

Turning to FIG. 3, an example embodiment of a harness 100 is illustrated being worn by a dog 101 with a leash 300 being coupled to the harness 100 at the chest 102 of the dog 101. In this example, the leash 300 comprises a leash strap 310 with a carabiner 320 coupled to a terminal end of the leash strap 310. As illustrated in FIG. 3, the carabiner 320 of the leash is coupled with the leash coupler 134 of the harness 100, with the leash strap 310 extending from the leash coupler 134 and through a loop passage 155 defined by a loop 153 on the left side of the harness 100 disposed on a left side of the dog 101.

In various embodiments, such a configuration can be for a human user walking the dog 101 while on the left side of the dog 101. In various embodiments, the harness has loops 152 on both the right and left sides of the harness 100, which can allow for the harness 100 and leash 300 to be selectively configured for the human user walking on either side of the dog 101 and harness 100 (i.e., on the right or left side).

As discussed in more detail herein, a harness 100 of various embodiments can be used for additional control during walks or training, can help the dog respond better to corrections, and the like. In various embodiments, the connection of the leash 300 to the chest 102 of the dog 101 and through the loop passage 155 defined by a loop 153 can effectively resist pulling by dogs, which can offer a distinct advantage in no-pull functionality. Such a configuration in various embodiments can create a similar feel to a bungee leash which allows for more of a slow stop instead of a hard stop and the loop 153 can act as a second point of resistance for the pulling dog in addition to a coupling at the center of the chest 102. Additionally, the harness 100 in FIG. 3 is shown fitted to the dog 101 such that the top handle 112 of the handle body 110 extends above the back 103 of the dog 101 to generate a handle gap 113 defined by the top handle 112 and the back 103 of the dog 101.

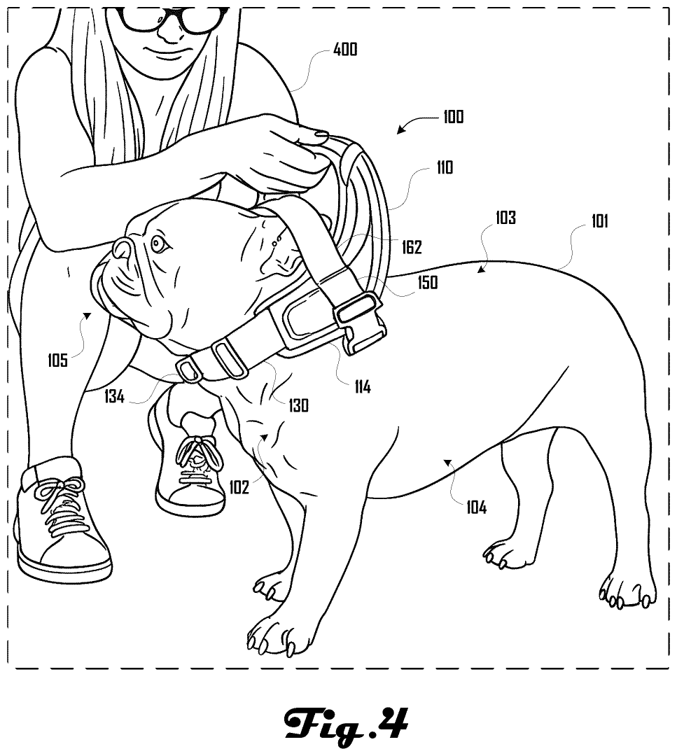

Turning to FIGS. 4-8, example steps of a method of coupling and/or fitting a harness 100 to an animal is illustrated. For example, FIG. 4 illustrates a human user 400 placing a harness 100 over the head 105 of a dog 101 though a space of the harness 100 defined by the top portion 162 of the torso strap assembly 150, a portion of the arms 114 of the of the handle body 110, and the front strap assembly 130.

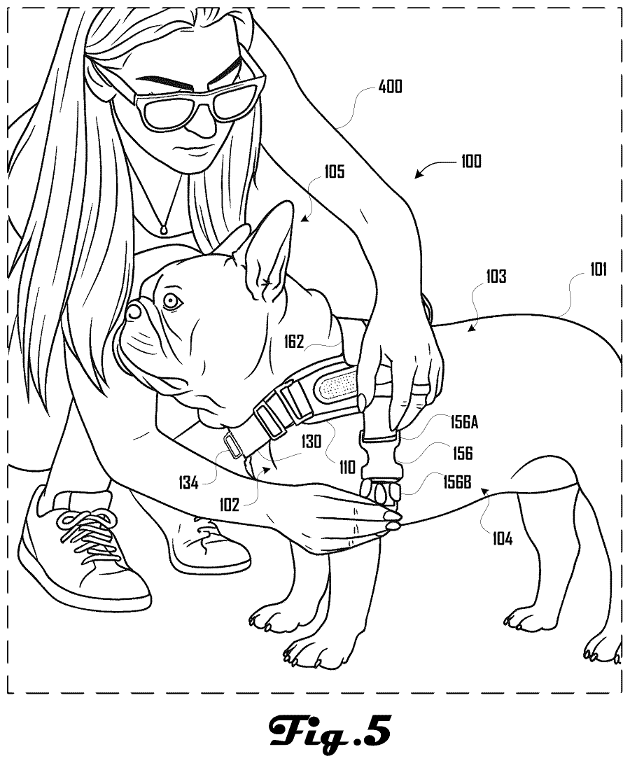

As shown in the example of FIG. 5, the harness 100 can be disposed on the dog 101 with the top portion 162 of the torso strap assembly 150 disposed on the back 103 of the dog 101 behind the head 105, which holds the handle body 110 about the torso 104 of the dog 101 with the front strap 130 extending around the chest 102 of the dog 101. Portions of the bottom portion 160 of the torso strap assembly 150 extend downward from the arms 114 of the handle body 110 and a portion of the bottom portion 160 of the torso strap assembly 150 having a male clip portion 156B of a clip 156 at a distal end can be extended under the torso 104 between the legs and couple with a female portion 156A of the clip 156 extending from an opposing side of the handle body 110 as shown in the example of FIG. 5.

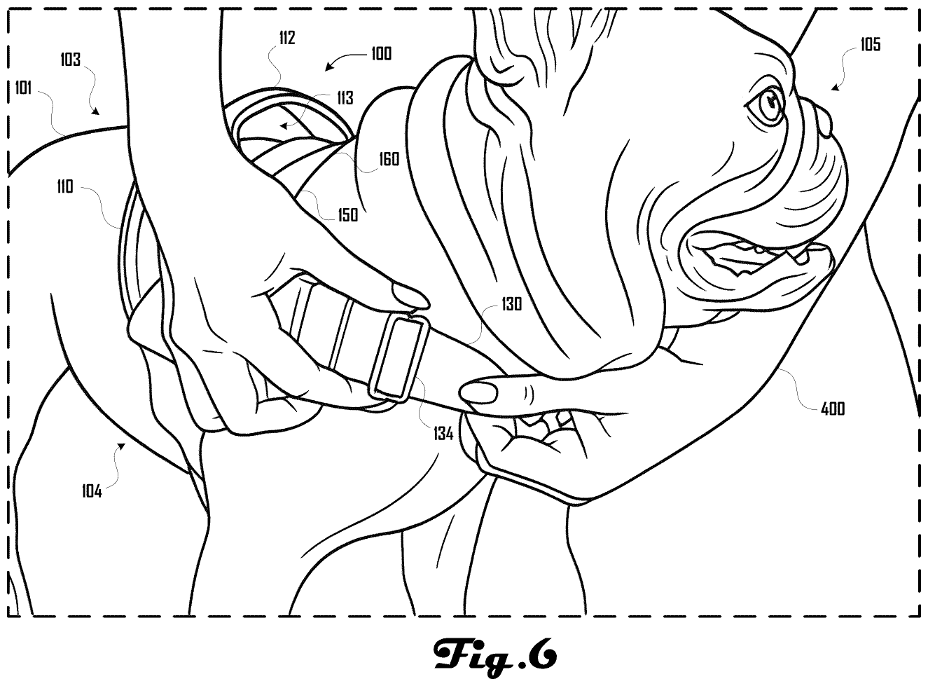

In various embodiments, it can be desirable to adjust the fit, sizing and/or positioning of a harness 100 once being worn by a dog 101. For example, it can be desirable for the harness 100 to fit snugly about the chest 102, back 103 and torso 104 of the dog 101 to provide for a secure fit on the body of the dog 101, but not so tight that the harness 100 is uncomfortable or restrictive to the dog 101. In various embodiments, elements such as the front strap assembly 130 and/or lower portion 160 of the torso strap assembly 150 can have an adjustable length (e.g., via one or more piece of front strap adjustment hardware 138, torso strap adjustment hardware 158, or the like). For example, in some embodiments, the front strap assembly 130 can comprise two pieces of front strap adjustment hardware 138 on opposing sides of the leash coupler 134, which can be desirable for adjusting the length of the front strap assembly 130 while also allowing for the leash coupler 134 to be positioned in the center of the chest 102 of the dog 101 or in another suitable or desired position on the chest 102 of the dog 101. FIG. 6 illustrates an example depiction of a human user 400 adjusting the fit of the front strap assembly 130 via front strap adjustment hardware 138.

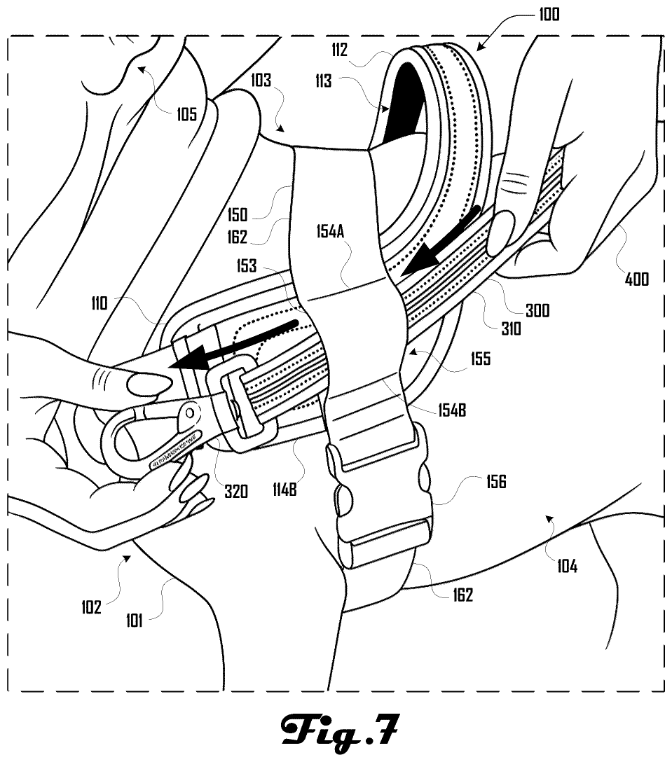

Turning to FIG. 7, an example illustration of a human user 400 threading a leash 300 through a loop passage 155 defined by a loop 153 of the torso strap assembly 150 defined by a portion of the torso strap 152 coupled to an arm 114 of the handle body 110 via top and bottom loop couplings 154A, 154B. As shown in the example of FIGS. 7, a carabiner 320 at the distal end of a leash strap 310 is passed through a posterior end of the loop passage 155 and through an anterior end of the loop passage 155 toward the chest 102 of the dog 101 such that leash strap 310 is movably disposed within the loop passage 155.

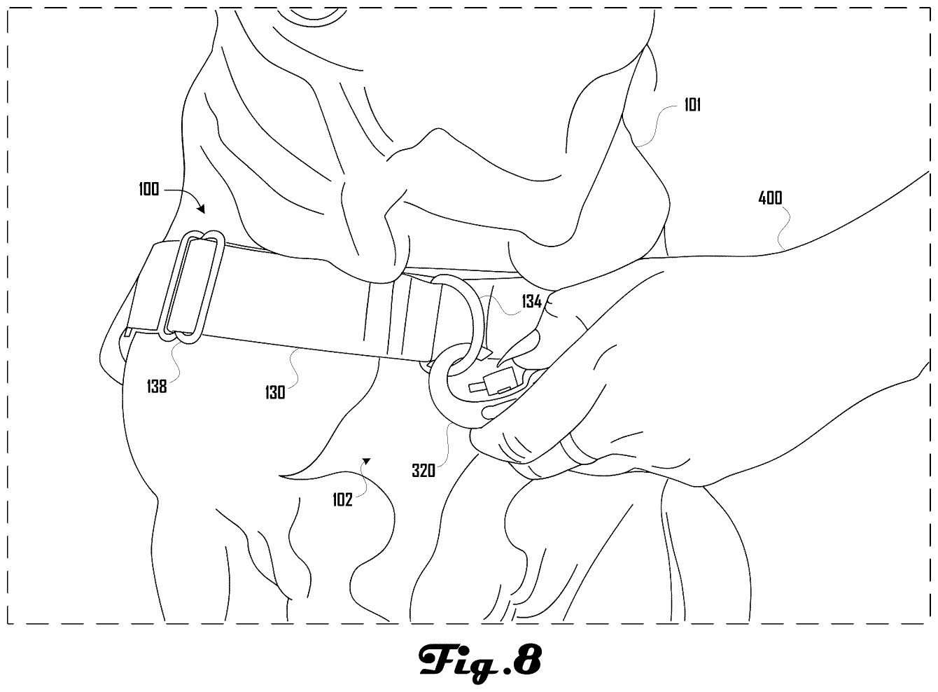

Turning to FIG. 8, the carabiner 320 of the leash 300 can be coupled to the leash-coupler 134 of the front strap assembly 130 of the harness 100. As discussed herein, while some examples include a leash 300 comprising a carabiner 320 and a leash-coupler 134 comprising a metallic D-ring, it should be clear that any suitable elements can be used in further embodiments to generate a coupling between a leash 300 and a leash-coupler 134 of the front strap assembly 130 of the harness 100.

The coupling between the leash 300 and the leash-coupler 134 at the chest 102 along with the leash strap 310 extending through one of the loop cavities 155 on the left or right side of a dog 101 can be desirable for additional control during walks or training, can help the dog 101 respond better to corrections during walking/leash training, and the like. In various examples, the coupling between the leash 300 and the leash-coupler 134 at the chest 102 along with the leash strap 310 extending through one of the loop cavities 155 on the left or right side of a dog 101 can effectively resist pulling by dogs, which can offer a distinct advantage in no-pull functionality. Such a configuration in various embodiments can create a similar feel to a dynamic or elastic leash, even where the leash 300 is static, non-elastic, or the like. Various embodiments allow for more of a slow stop instead of a hard stop, and the loop 153 can act as a sliding second point of resistance for the pulling dog 101 in addition to the coupling at the center of the chest 102 between the leash 300 and the leash-coupler 134 of the harness 100.

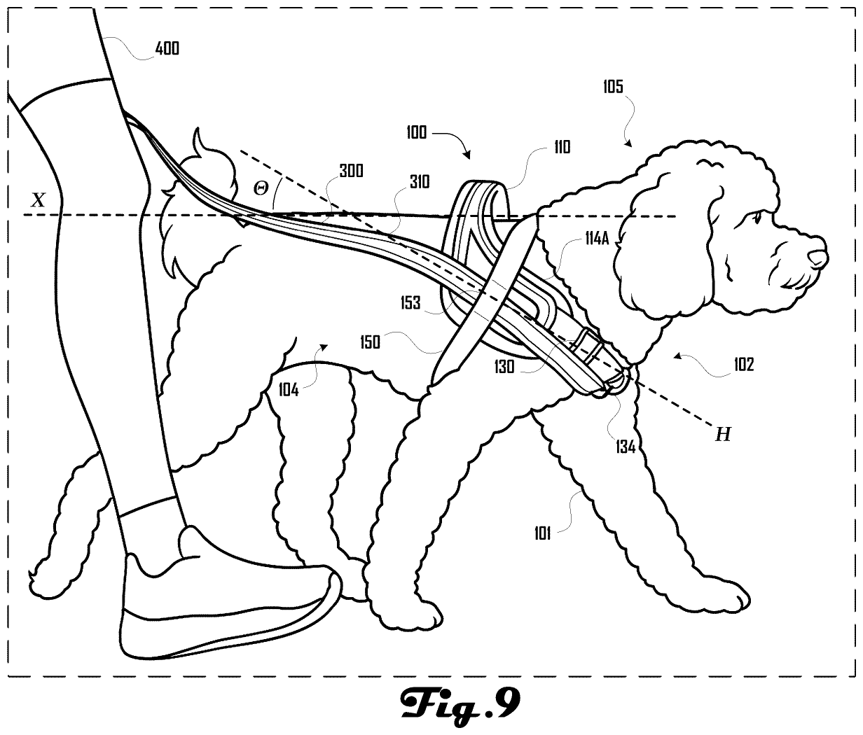

For example, FIG. 9 illustrates an example of a dog 101 being walked or trained by a human user 400 where the user 400 is walking alongside the dog on the same side of a harness 100 where a leash 300 extends through a loop cavity 155 on the right side of the dog 101 and couples with a leash-coupler 134 of the harness 100 disposed at the chest 102 of the dog 101. In such an example, where the dog 101 moves away from the user 400 or otherwise pulls on the leash 300, the slidable coupling between the leash strap 310 through the loop cavity 155 can allow any slack in the leash strap 310 between the loop 153 and the leash-coupler 134 to be pulled taught, with the loop 153 then acting as a point of resistance. Additional pulling by the dog 101 can then generate lateral resistance from the engagement between the loop 153 and leash strap 310 and can also generate a lateral or rotational force at the chest 102 of the dog 101 based on the coupling between the leash 300 and the leash-coupler 134 (e.g., via a carabiner 320 coupled at a terminal end of the leash strap 310 of the leash 300). Accordingly, some such configurations can allow for lateral and/or rotational force on a dog 101 at side and/or chest of the dog 101, which can be desirable for additional control during walks or training, can help the dog 101 respond better to corrections during walking/leash training, and the like.

In various embodiments, the loop(s) 153 of the harness 100 can be disposed in various suitable locations on the dog 101; however, in some preferred embodiments the loop(s) 153 of the harness 100 are disposed behind/posterior to the shoulder joint of the dog 101 defined by the humerus and scapula of the dog 101. In some embodiments, a main axis of one or more loops 153 can be coincident with the axis of the shoulder joint of the dog 101. Additionally, the torso strap assembly 150 can be disposed in various suitable locations on a dog 101; for example, encircling the torso 104 of the dog 101 with the bottom portion 160 of the torso strap assembly 150 directly behind the front legs of the dog 101 and the top portion 162 of the torso strap assembly 150 directly behind the head 105 of the dog 101 on the back and/or neck of the dog 101.

Additionally, in various embodiments, a main axis of the arms 114 and/or the front strap assembly 130 can be disposed at various suitable angles relative to the back 103 of the dog 101 and the ground (e.g., perpendicular to gravity). For example, FIG. 9 illustrates an example of a harness axis H (e.g., a main axis of the arms 114 and/or the front strap assembly 130) being at an angle θ of 30 degrees from and an axis X (e.g., an axis of the back 103 of the dog 101 or parallel to the ground). In further embodiments, the angle θ can be various suitable angles, including, parallel to each other, 5, 10, 15, 20, 25, 30, 35, 40, 45, 50, 55, 60, 65, 70, 75, 80, 85, 90 degrees, or the like, or a range between such example values. Some preferred embodiments include an angle θ of between 25 and 35 degrees, 20 and 40 degrees, or 15 and 45 degrees.

Additionally, in embodiments where a harness 100 has loops 153 on both sides of the handle body 110, a user 400 can selectively configure the harness 100 and leash 300 for walking the dog 101 on the left or right side by selectively threading the leash 300 through the loop 153 on the left or right side of the harness 100.

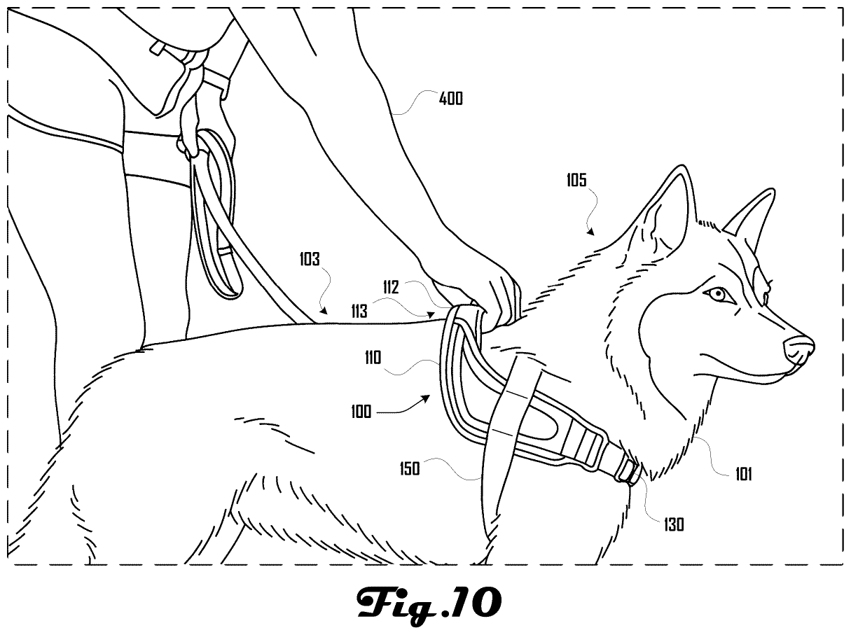

Turning to FIG. 10, an example of a user 400 grasping the top handle 112 of the handle body 110 of an embodiment of the harness 100 is illustrated. Specifically, the user 400 is shown grasping the top handle 112 with fingers extending into a handle gap 113 defined by the top handle 112 and the back 103 of the dog 101. As shown in this example, the top handle 112 is disposed directly behind the head 105 of the dog 101, but in various embodiments, the top handle can be disposed in various suitable locations on a dog 101, including various locations down the back 103 of the dog 101, around and about the head 105 of the dog 101, or the like.

While various embodiments can relate to a dog, further embodiments can be configured for any suitable animal, including a human animal in some embodiments. For example, dogs, cats, rabbits, ferrets, goats, pigs, sheep, alpacas, llamas, horses, monkeys, foxes, raccoons, kangaroos, wallabies, iguanas, parrots, falcons, turtles, bearded dragons, capybaras, porcupines, hedgehogs, badgers, skunks, otters, and the like.

Various embodiments herein relate to a method of walking and or training an animal (e.g., a dog). Such a method can include fitting a dog with a harness 100 that includes three cooperating sub-assemblies that together provide comfort, control, and an intuitive training aid. A handle body 110 can form the structural backbone of the harness 100 in some examples. This handle body 110 in some embodiments can be fabricated from a padded, flexible material that nevertheless retains a semi-rigid shape. A curved, generally U-shaped top handle 112 can bridge the dog's left and right flanks and can project upward so that the top handle 112 remains spaced above the back 103, establishing a handle gap 113 of roughly two to four inches in some embodiments. That clearance can allow a handler to seize the handle quickly without stooping or compressing the spine of the dog. From the base of the top handle 112, a pair of elongated arms 114A and 114B can extend laterally along opposite sides of the torso. Each arm can present a planar front face, the two faces lying parallel to one another and perpendicular to the peak tangent of the top handle so that the handle body forms a symmetric, robust frame against the dog's ribs.

Coupled to distal ends of the arms 114 can be a front-strap assembly 130. A front strap 132 can encircle the chest 102 and can include at the midpoint of the chest 102, a leash-coupler 134 that can be a welded D-ring sewn directly into webbing of the front strap assembly. One or two adjustment slides 138 may flank the D-ring so the strap length can be set without displacing the leash-coupler 134 from the dog's sternum. Behind the forelegs, a torso-strap assembly 150 encircles the torso of the dog 101, which can include a continuous torso strap 152 that is stitched to each arm 114 of the handle body 110 via top and bottom loop couplings 154A and 154B, thereby creating on each side a coupling loop 153 that bulges outward to form a D-shaped loop passage 155. The outward bow arises because the circumferential length of the strap segment exceeds the stitched span between the two couplings; the resulting loop passage 155 can be wide enough to admit a leash 300 and provides minimal friction as the leash 300 slides within the loop passage 155. A fixed-length top portion 162 of the torso strap spans the dog's back immediately behind the neck and can stabilize the handle body 110 in various examples, while a lower portion 160 beneath the torso carries a releasable clip 156 and, if desired, adjustment hardware 158 for final cinching beneath the belly. To keep the handle gap constant, in some embodiments, no adjustment devices are placed on the top handle or the top portion of the torso strap.

Fitting the harness 100 can begin by sliding the handle body and front-strap assembly over the dog's head so that the arms 114 lie flush against the left and right flanks and the top handle hovers above the shoulders. The lower portion of the torso strap 150 is then guided under the ribcage, immediately behind the front legs, and the clip 156 is fastened. The user can shorten or lengthen the front strap 132 via the adjustment slides until the leash coupler 134 (e.g., a D-ring) rests centrally on the dog's chest while still permitting free breathing, and tightens the torso-strap adjustment hardware to a desired. In some embodiments where the top strap is fixed, these adjustments do not alter the elevation of the top handle.

With the harness 100 adjusted, the handler in various examples routes a static, non-elastic leash 300 through one of the loop passages 155. Standing on the same side of the dog as the selected loop, the user inserts the leash strap 310 through the posterior opening of the loop and out the anterior opening toward the chest of the dog. A coupling element (e.g., a carabiner 320 at a terminal end of the leash 300) can then be coupled to the leash coupler (e.g., a D-ring 134), leaving the leash strap 310 freely slidable within the loop passage 155. When the dog maintains a loose-leash position, the strap glides with negligible friction within the loop passage 155. If the dog surges forward or to the side, slack between the loop 153 and the chest coupler 134 is taken up; the loop 153 then acts as the first point of resistance, redirecting leash force laterally toward the handler rather than directly rearward. Continued tension can rotate the front of the harness inward because the leash coupler 134 can be anchored at the chest, producing a gentle turning moment that invites the dog 101 back into position. The combined lateral check at the loop 153 and rotational cue at the chest 101 can deliver a progressive, bungee-like slow stop, discouraging hard lunges and reinforcing polite walking without harsh collar corrections. Because the corrective forces are applied early and smoothly, peak leash tension can markedly lower than with conventional harnesses.

The elevated top handle remains available at all times for immediate control, for example when navigating crowds or assisting an elderly or injured animal over obstacles. The harness is largely symmetric about its mid-sagittal plane so that the leash 300 can be threaded through either the left or right coupling loop 155 depending on which side the handler prefers to walk.

In operation a harness and training method can combine the elevated handle body 110, centrally positioned chest coupler 134, and outwardly bulged side loops 153 to redirect a dog before full pulling force develops, reducing strain on both dog and handler while establishing clear, repeatable cues for loose-leash walking. These structural features can cooperate in various embodiments to create a humane, easy-to-fit system that yields progressive resistance rather than abrupt jerks, thereby fostering better leash manners through consistent, gentle guidance.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A method of walking and training a dog, the method comprising:
putting a harness on a dog, the harness including:
a handle body comprising a top handle that defines a curved U-shaped body that extends downward to a pair of arms that engage the body of the dog and extend laterally on opposing sides of the torso of the dog, the handle body being a soft, flexible and yet semi-rigid body,
a front strap assembly coupled to the handle body by the front strap assembly being coupled at respective distal ends of the arms, the front strap assembly including a front strap and a leash-coupler disposed centrally at the front strap assembly, the front strap assembly extending around the chest of the dog with the leash-coupler disposed centrally at the chest of the dog, and
a torso strap assembly coupled to the handle body, the torso strap assembly encircling the torso of the dog behind the neck and the front legs of the dog and comprising a torso strap that defines a pair of coupling loops respectively on the arms of the handle body, which are defined by lengths of the torso strap coupled to external faces of the arms via top and bottom loop couplings, the coupling loops and respective external faces of the arms defining a respective loop passage configured to slidably hold a leash, the torso strap assembly further comprising a lower portion extending below the coupling loops and a top portion extending above the coupling loops, with the lower portion of the torso strap configured to be coupled and decoupled via a clip, the arms extending laterally on opposing sides of the torso of the dog and defining respective front faces having respective planes that are generally parallel to each other and perpendicular to a peak tangent of the top handle,
wherein the handle body is disposed on opposing sides of the torso of the dog such that the top handle remains spaced apart from the back of the dog creating a cavity between the top handle and the back of the dog such that the top handle is graspable by a user,
wherein the top portion of the torso strap assembly rests on the back of the dog and has a fixed length that allows the top handle to remain spaced apart from the back of the dog and creating the cavity between the top handle and the back of the dog having a distance between the back of the dog and the top handle of between 2.0 and 4.0 inches;
coupling the lower portion of the torso strap about the belly of the dog behind the front legs of the dog by coupling the clip together;
adjusting the fit of the harness on the dog via a plurality of adjustment hardware elements of the front strap assembly and via at least one adjustment hardware element of the lower portion of the torso strap;
passing a leash through one of the respective loop passages toward the chest of the dog, including by passing a carabiner disposed at a terminal end of a leash strap of the leash through the one of the respective loop passages so that the leash strap extends through the one of the respective loop passages;
clipping the carabiner to the leash-coupler disposed at the center of the chest of the dog to couple the leash to the harness, with the leash strap of the leash being slidably disposed within the one of the respective loop passages and the leash being static and non-elastic; and
walking parallel and adjacent to the dog on the same side as the one of the respective loop passages through which the leash strap of the leash is slidably disposed, wherein where the dog moves away or otherwise pulls on the leash, the slidable coupling between the leash strap through the one of the respective loop passages causes slack in the leash strap between the coupling loop and the leash-coupler to be pulled taught, with the coupling loop then acting as a point of resistance, and where additional pulling by the dog then generates lateral resistance from the engagement between the coupling loop and leash strap and also generates a lateral or rotational force at the chest of the dog based on the coupling between the leash and the leash-coupler via the carabiner, wherein the lateral resistance from the engagement between the coupling loop and leash strap and the lateral or rotational force at the chest of the dog is used to train the dog.

2. The method of walking and training a dog of claim 1, wherein the leash-coupler includes a D-ring sewn into the front of the front strap assembly.

3. The method of walking and training a dog of claim 1, wherein adjustment hardware elements are absent from the top portion of the torso strap and absent from the handle body such that the top portion of the torso strap the handle body are of a fixed size and length.

4. The method of walking and training a dog of claim 1, wherein the length of the respective coupling loops defined by the torso strap are of a greater than the distance between the top and bottom loop couplings, which causes the portions of the torso strap that define the respective coupling loops to bulge outward based on rigidity of the arms of the handle body keeping the arms planar, with such bulging of the coupling loops defining the respective loop passages having a D-shape that allows the leash to be easily passed through the loop passages and to provide minimal resistance to the leash strap of the leash sliding through the loop passages.

5. A method of walking and training a dog, the method comprising:
putting a harness on a dog, the harness including:
a handle body comprising a top handle that defines a curved U-shaped body that extends downward to a pair of arms that engage the body of the dog and extend laterally on opposing sides of the torso of the dog,
a front strap assembly coupled to the handle body by the front strap assembly being coupled at respective distal ends of the arms, the front strap assembly including a front strap and a leash-coupler disposed centrally at the front strap assembly, the front strap assembly extending around the chest of the dog with the leash-coupler disposed centrally at the chest of the dog, and
a torso strap assembly coupled to the handle body, the torso strap assembly encircling the torso of the dog behind the neck and the front legs of the dog and comprising a torso strap that defines a pair of coupling loops respectively on the arms of the handle body, which are defined by lengths of the torso strap coupled to external faces of the arms via top and bottom loop couplings, the coupling loops and respective external faces of the arms defining a respective loop passage configured to slidably hold a leash, the torso strap assembly further comprising a lower portion extending below the coupling loops and a top portion extending above the coupling loops,
passing a leash through one of the respective loop passages toward the chest of the dog, including by passing a coupling element disposed at a terminal end of a leash strap of the leash through the one of the respective loop passages so that the leash strap extends through the one of the respective loop passages;
coupling the coupling element with the leash-coupler disposed at the center of the chest of the dog to couple the leash to the harness, with the leash strap of the leash being slidably disposed within the one of the respective loop passages and the leash being static and non-elastic; and
walking parallel and adjacent to the dog on the same side as the one of the respective loop passages through which the leash strap of the leash is slidably disposed, wherein where the dog moves away or otherwise pulls on the leash, the slidable coupling between the leash strap through the one of the respective loop passages causes slack in the leash strap between the coupling loop and the leash-coupler to be pulled taught, with the coupling loop then acting as a point of resistance, and where additional pulling by the dog then generates lateral resistance from the engagement between the coupling loop and leash strap and also generates a lateral or rotational force at the chest of the dog based on the coupling between the leash and the leash-coupler via the coupling element, wherein the lateral resistance from the engagement between the coupling loop and leash strap and the lateral or rotational force at the chest of the dog is used to train the dog.

6. The method of walking and training a dog of claim 5, wherein the lower portion of the torso strap is configured to be coupled and decoupled via a clip.

7. The method of walking and training a dog of claim 5, wherein the arms extend laterally on opposing sides of the torso of the dog and define respective front faces having respective planes that are generally parallel to each other and perpendicular to a peak tangent of the top handle.

8. The method of walking and training a dog of claim 5, wherein the handle body is disposed on opposing sides of the torso of the dog such that the top handle remains spaced apart from the back of the dog creating a cavity between the top handle and the back of the dog such that the top handle is graspable by a user.

9. The method of walking and training a dog of claim 8, wherein the top portion of the torso strap assembly rests on the back of the dog and has a fixed length that allows the top handle to remain spaced apart from the back of the dog and creating the cavity between the top handle and the back of the dog having a distance between the back of the dog and the top handle of between 2.0 and 4.0 inches.

10. A method of walking and training a dog, the method comprising:
putting a harness on a dog, the harness including:
a handle body comprising a top handle,
a front strap assembly coupled to the handle body by the front strap assembly being coupled at respective distal ends of the arms, the front strap assembly including a front strap and a leash-coupler disposed centrally at the front strap assembly, the front strap assembly extending around the chest of the dog with the leash-coupler disposed centrally at the chest of the dog, and
a torso strap assembly coupled to the handle body, the torso strap assembly encircling the torso of the dog behind the neck and the front legs of the dog and comprising a torso strap that defines a pair of coupling loops respectively on the arms of the handle body, which are defined by lengths of the torso strap coupled to external faces of the arms, the coupling loops and respective external faces of the arms defining a respective loop passage configured to slidably hold a leash, the torso strap assembly further comprising a lower portion extending below the coupling loops and a top portion extending above the coupling loops,
passing a leash through one of the respective loop passages, including by passing a coupling element of the leash through the one of the respective loop passages so that a leash strap of the leash extends through the one of the respective loop passages;
coupling the coupling element with the leash-coupler disposed at the center of the chest of the dog to couple the leash to the harness; and
walking parallel and adjacent to the dog on the same side as the one of the respective loop passages through which the leash strap of the leash is slidably disposed, wherein where the dog moves away or otherwise pulls on the leash, the slidable coupling between the leash strap through the one of the respective loop passages causes slack in the leash strap between the coupling loop and the leash-coupler to be pulled taught, with the coupling loop then acting as a point of resistance.

11. The method of walking and training a dog of claim 10, wherein the handle body comprising a top handle that defines a curved U-shaped body that extends downward to a pair of arms that engage the body of the dog and extend laterally on opposing sides of the torso of the dog.

12. The method of walking and training a dog of claim 10, wherein the pair of coupling loops are defined by lengths of the torso strap coupled to external faces of the arms via top and bottom loop couplings.

13. The method of walking and training a dog of claim 10, wherein passing a leash through one of the respective loop passages includes by passing the coupling element disposed at a terminal end of the leash strap of the leash toward the chest of the dog through the one of the respective loop passages so that the leash strap extends through the one of the respective loop passages.

14. The method of walking and training a dog of claim 10, further comprising coupling the coupling element with the leash-coupler disposed at the center of the chest of the dog to couple the leash to the harness, with the leash strap of the leash being slidably disposed within the one of the respective loop passages and the leash being static and non-elastic.

15. The method of walking and training a dog of claim 10, wherein additional pulling by the dog generates lateral resistance from engagement between the coupling loop and leash strap.

16. The method of walking and training a dog of claim 10, wherein additional pulling by the dog generates a lateral or rotational force at the chest of the dog based on the coupling between the leash and the leash-coupler via the coupling element.

17. The method of walking and training a dog of claim 10, wherein lateral resistance from engagement between the coupling loop and leash strap and/or lateral or rotational force at the chest of the dog is used to train the dog.

18. The method of walking and training a dog of claim 10, wherein the handle body is disposed on opposing sides of the torso of the dog such that the top handle remains spaced apart from the back of the dog creating a cavity between the top handle and the back of the dog such that the top handle is graspable by a user.

19. The method of walking and training a dog of claim 10, wherein the top portion of the torso strap assembly rests on the back of the dog and has a fixed length that allows the top handle to remain spaced apart from the back of the dog and creating a cavity between the top handle and the back of the dog.
